(19) United States
(12) Patent Application Publication
(10) Pub. No.: US 2024/0093531 A1
(43) Pub. Date: Mar. 21, 2024

(54) DOOR LOCK CASE

(71) Applicant: POWERTEK HARDWARE CO., LTD., TAICHUNG (TW)

(72) Inventor: Chung-Yu CHEN, Taichung (TW)

(21) Appl. No.: 18/464,754

(22) Filed: Sep. 11, 2023

(30) Foreign Application Priority Data
Sep. 19, 2022 (TW) 111135376

(51) Int. Cl. E05B 9/02; E05B 13/00; E05B 47/00; E05B 63/10

(52) U.S. Cl. CPC E05B 9/02; E05B 13/002; E05B 47/0012; E05B 63/10; E05B 15/04; E05B 2047/0017; E05B 2047/002; E05B 2047/0084

(57) ABSTRACT

A door lock case has a main body. The main body includes a square tongue therein. The square tongue is connected with an electric control unit and a manual control unit. The electric control unit has a driving member. The driving member is connected with a driven member. The driven member is connected to the square tongue. The electric control unit further has a drive source. The drive source first drives the driving member to move the driven member, so that the driven member moves the square tongue to an unlocked position and then drives the driving member to move to a clutch position, so that the driving member is disengaged from the driven member. In this way, the user can directly open the door to pass through the door after unlocking and can control the movement of the square tongue manually via the manual control unit.

### FIELD OF THE INVENTION

The present invention relates to a door lock case, and more particularly to a door lock case for access control.

### BACKGROUND OF THE INVENTION

When a conventional door lock case is locked, a stopper is usually controlled by a solenoid valve to block the rear of the lock tongue of the door lock case, so that the lock tongue cannot be retracted into the door lock case. In this way, when unlocking, the user needs to operate the solenoid valve to release the stopper, and then the lock tongue is driven and retracted into the door lock case by the handle of the door lock case, so as to open the door. It is not convenient to operate the door lock case. Besides, it is impossible to lock and unlock manually with a key or other manual means. When the door is opened, the lock tongue of the conventional door lock case may be ejected from the door lock case due to a wrong operation. As a result, the door panel cannot be closed properly.

### SUMMARY OF THE INVENTION

The primary object of the present invention is to provide a door lock case, which can directly open the door after unlocking and can be operated manually for locking and unlocking. It is more intuitive and convenient in operation.

In order to achieve the foregoing object, a door lock case provided by the present invention comprises a main body. The main body has an accommodation space therein. The main body is formed with a square tongue opening and a manual control opening. The square tongue opening and the manual control opening communicates with the accommodation space. The main body includes a square tongue. The square tongue is disposed in the accommodation space. The square tongue is configured to slide in an axial direction of the square tongue opening to be in a locked position in which the square tongue is extended out of the square tongue opening or in an unlocked position in which the square tongue is retracted into the square tongue opening. The square tongue has a force-receiving portion. The main body further includes an electric control unit. The electric control unit is disposed in the accommodation space. The electric control unit includes a driving member, a driven member, and a power source. The driving member has a driving portion. The driven portion has a driven portion corresponding to the driving portion and a force-applying portion corresponding to the force-receiving portion of the square tongue. The power source is connected to the driving member. When the square tongue is in the locked position, the power source is activated to drive the driving member, so that the driving member drives the driven member through the driving portion to drive the driven portion, and then the driven member drives the square tongue to move to the unlocking position through the force-applying member to drive the force-receiving member. When the square tongue is moved to the unlocking position, the power source drives the driving member to move reversely to a clutch position, and a distance is kept between the driving portion and the driven portion. The main body further includes a manual control unit. The manual control unit is disposed at the manual control opening. The manual control unit is configured for a user to move the square tongue manually between the locked position and the unlocked position when the driving member is in the clutch position.

When the user enters the correct unlocking command, the electric control unit will move the square tongue to the unlocked position, so that the user can directly open the door to pass through the door. When the square tongue is moved to the unlocked position, the power source will drive the driving member to rotate reversely to the clutch position, so that the user can operate the square tongue to move via the manual control unit. The door lock case can be controlled manually so that the user can operate the door lock case in an intuitive and convenient manner.

### BRIEF DESCRIPTION OF THE DRAWINGS

FIG. 1 is an exploded view according to a first embodiment of the present invention;

FIG. 2 is a cross-sectional view according to the first embodiment of the present invention;

FIG. 3 is a partial cross-sectional view illustrating the anti-prying tongue according to the first embodiment of the present invention;

FIG. 4 is a partial cross-sectional view illustrating the electric control unit according to the first embodiment of the present invention;

FIG. 5 is a partial cross-sectional view illustrating the handle control unit according to the first embodiment of the present invention;

FIG. 6 is a schematic view of the first embodiment of the present invention when the door is closed and locked;

FIG. 7 is a schematic view of the first embodiment of the present invention when the door is unlocked by the electric control unit;

FIG. 8 is a schematic view of the first embodiment of the present invention when the door is closed and unlocked;

FIG. 9 is a schematic view of the first embodiment of the present invention when the door is opened and unlocked;

FIG. 10 is a schematic view of the first embodiment of the present invention, wherein the electric control unit is rotated reversely;

FIG. 11 is a schematic view of the first embodiment of the present invention when the door is to be closed;

FIG. 12 is a schematic view of the first embodiment of the present invention after the door is closed;

FIG. 13 is a schematic view of the use of the manual control unit of the first embodiment of the present invention;

FIG. 14 is another schematic view of the use of the manual control unit of the first embodiment of the present invention;

FIG. 15 is a schematic view of the use of the handle control unit of the first embodiment of the present invention; and

FIG. 16 is a cross-sectional view according to a second embodiment of the present invention.

### DETAILED DESCRIPTION OF THE PREFERRED EMBODIMENTS

Embodiments of the present invention will now be described, by way of example only, with reference to the accompanying drawings.

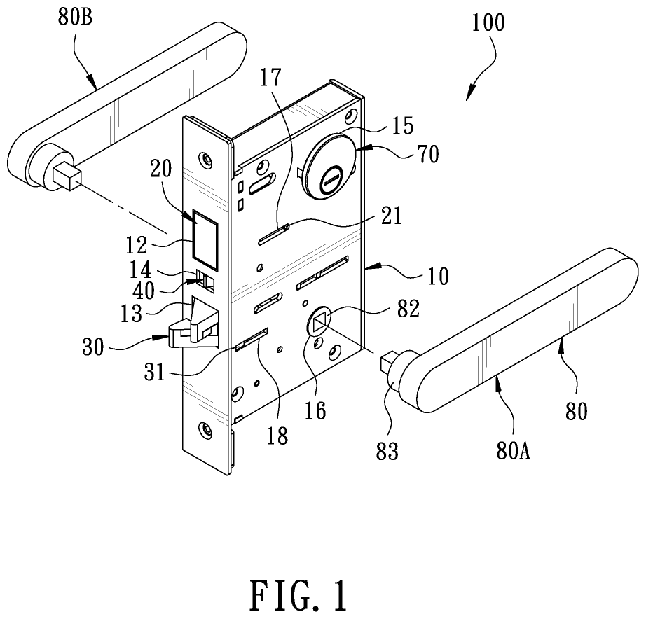

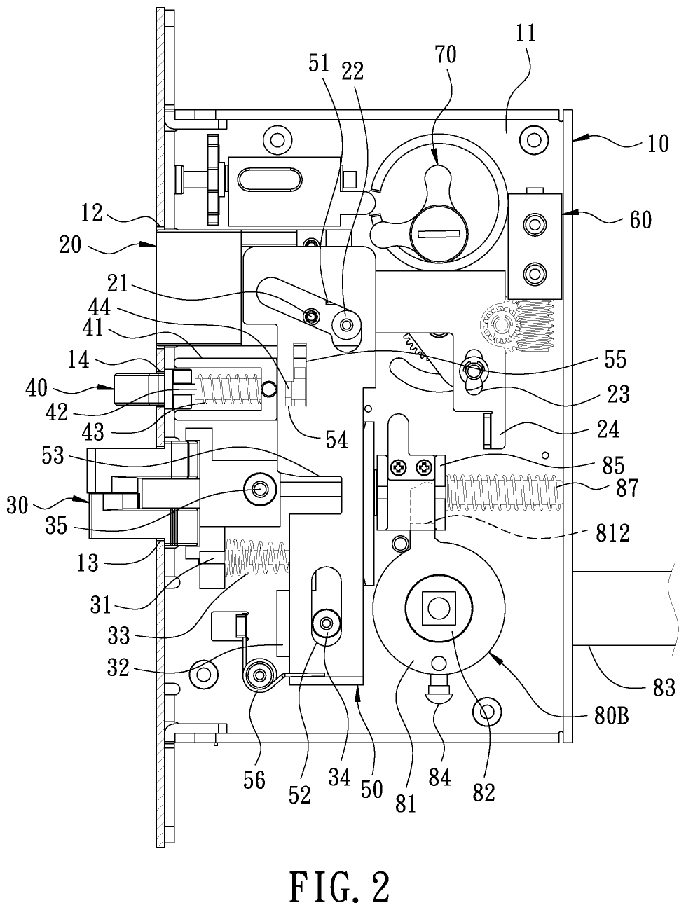

FIG. 1 is an exploded view according to a first embodiment of the present invention. FIG. 2 is a cross-sectional view according to the first embodiment of the present invention. The present invention discloses a door lock case 100. In this embodiment, the door lock case is a US standard door lock case and comprises a main body 10. The main body 10 has an accommodation space 11 therein. The main body 10 is formed with a square tongue opening 12, an oblique tongue opening 13, an anti-prying tongue opening 14, a manual control opening 15 and at least one handle opening 16 that all communicate with the accommodation space 11. The door lock case 100 includes a square tongue 20 corresponding in position to the square tongue opening 12, an oblique tongue 30 corresponding in position to the oblique tongue opening 13, an anti-prying tongue 40 corresponding in position to the anti-prying tongue opening 14, and a restricting member 50 connected among the square tongue 20, the oblique tongue 30 and the anti-prying tongue 40. The square tongue 20, the oblique tongue 30, the anti-prying tongue 40 and the restricting member 50 are all disposed in the accommodation space 11. In addition, in order to control the locking and unlocking of the square tongue 20, the door lock case 100 further includes an electric control unit 60 behind the square tongue 20, a manual control opening 15 that is arranged in the accommodation space 11 and corresponds in position to the manual control opening 15, and at least one handle control unit 80 that is arranged at the handle opening 16. In this embodiment, either side of the main body 10 is formed with the handle opening 16. A handle control unit 80A is disposed on the outer side of the main body 10, and a handle control unit 80B is disposed on the inner side of the main body 10.

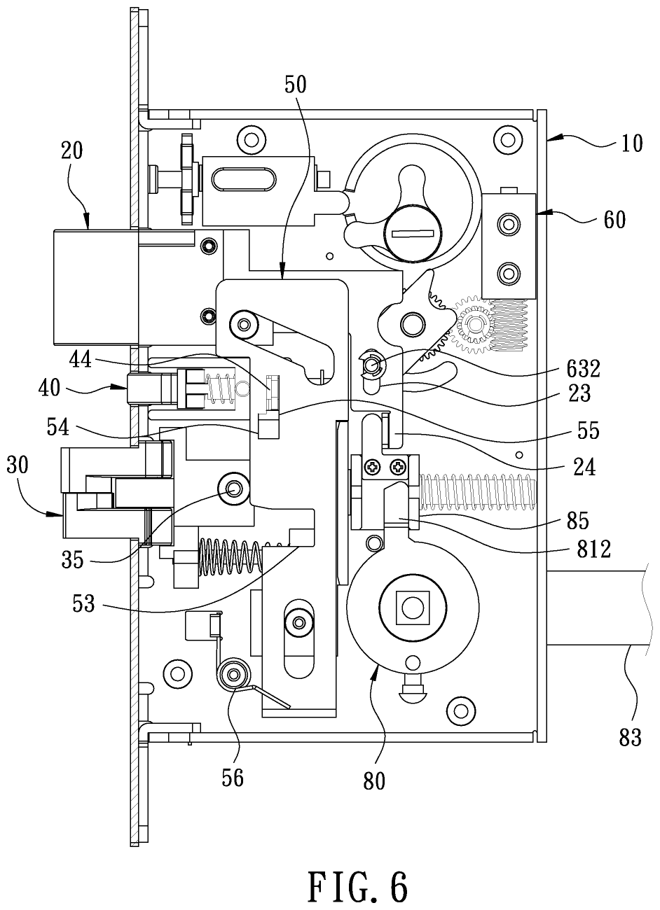

Referring to FIG. 2, the square tongue 20 includes at least one square tongue guide post 21. The square tongue guide post 21 is inserted in a square tongue guide groove 17 as shown in FIG. 1, so that the square tongue 20 can slide in the axial direction of the square tongue opening 12 to be in a locked position in which the square tongue 20 is extended out of the square tongue opening 12 as shown in FIG. 6, or in an unlocked position in which the square tongue 20 is retracted into the square tongue opening 12 as shown in FIG. 2.

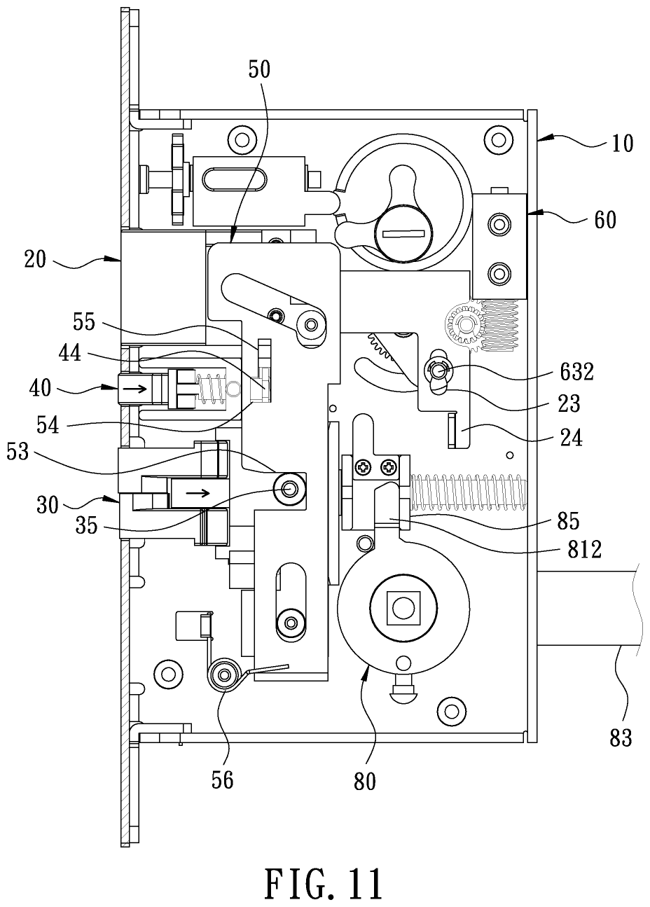

Referring to FIG. 2, the oblique tongue 30 includes at least one oblique tongue guide post 31. The oblique tongue guide post 31 is inserted in an oblique tongue guide groove 18 as shown in FIG. 1, so that the oblique tongue 30 can slide in the axial direction of the oblique tongue opening 13 to be in an extended position in which the oblique tongue 30 is extended out of the oblique tongue opening 13 as shown in FIG. 2, or in a retracted position in which the oblique tongue 30 is retracted into the oblique tongue opening 13 as shown in FIG. 11. The main body 10 further includes an oblique tongue holder 32 and an oblique tongue spring 33 between the oblique tongue 30 and the oblique tongue holder 32. The oblique tongue spring 33 is configured to push the oblique tongue 30 to move toward the extended position. The oblique tongue 30 is a two-way oblique tongue. The two-way oblique tongue is a conventional structure, so it will not be repeated here.

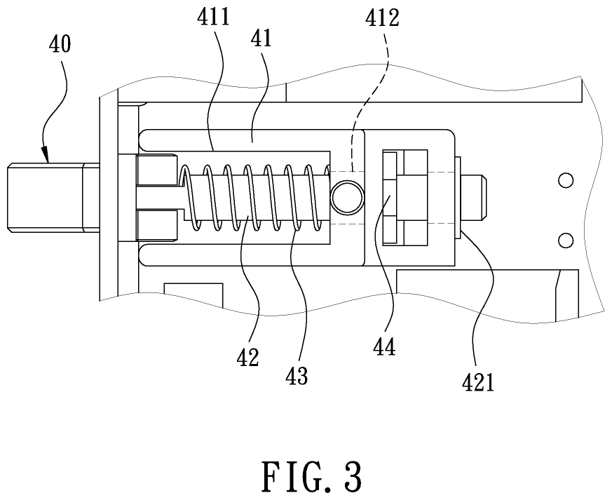

FIG. 3 is a partial cross-sectional view illustrating the anti-prying tongue according to the first embodiment of the present invention. As shown in FIG. 2 and FIG. 3, the main body 10 further includes an anti-prying tongue holder 41. The anti-prying tongue holder 41 has a slide groove 411. The anti-prying tongue 40 is slidable in the slide groove 411, so that the anti-prying tongue 40 can slide in the axial direction of the anti-prying tongue opening 14 to be in a door-opening position in which the anti-prying tongue 40 is extended out of the anti-prying tongue opening 14 as shown in FIG. 2, or in a door-closing position in which the anti-prying tongue 40 is retracted into the anti-prying tongue opening 14 as shown in FIG. 11. The anti-prying tongue holder 41 further has a shaft hole 412 communicating with the slide groove 411. The anti-prying tongue 40 is connected with a shaft 42. The other end of the shaft 42 passes through the shaft hole 412 and is connected to a restricting portion 421. An anti-pry tongue spring 43 is provided on the shaft 42. The anti-pry tongue spring 43 is configured to push the anti-pry tongue 40 to move toward the door-opening position.

Referring to FIG. 2, the square tongue 20 further includes a rotatable square tongue guide wheel 22, and the oblique tongue holder 32 includes a rotatable oblique tongue guide wheel 34. The restricting member 50 has a guide chute 51 corresponding to the square tongue guide wheel 22 and a guide slot 52 corresponding to the oblique tongue guide wheel 34. The restricting member 50 is driven by the square tongue 20 to be in a first position corresponding to the locked position as shown in FIG. 6 or in a second position corresponding to the unlocked position as shown in FIG. 2. The oblique tongue 30 includes an oblique tongue stopper 35. The restricting member 50 includes an oblique tongue positioning portion 53 corresponding to the oblique tongue stopper 35. In this embodiment, the oblique tongue stopper 35 is a post. The oblique tongue positioning portion 53 is a notch. The anti-pry tongue 40 includes an anti-pry tongue stopper 44. The restricting member 50 includes an anti-pry tongue positioning portion 54 corresponding to the anti-pry tongue stopper 44. In this embodiment, the anti-pry tongue stopper 44 is a protruding block disposed on the shaft 42, and the anti-pry tongue positioning portion 54 is a transverse groove. The restricting member 50 further includes a longitudinal groove 55 communicating with the anti-pry tongue positioning portion 54 and a restricting member spring 56 configured to elastically drive the restricting member 50 to move toward the first position.

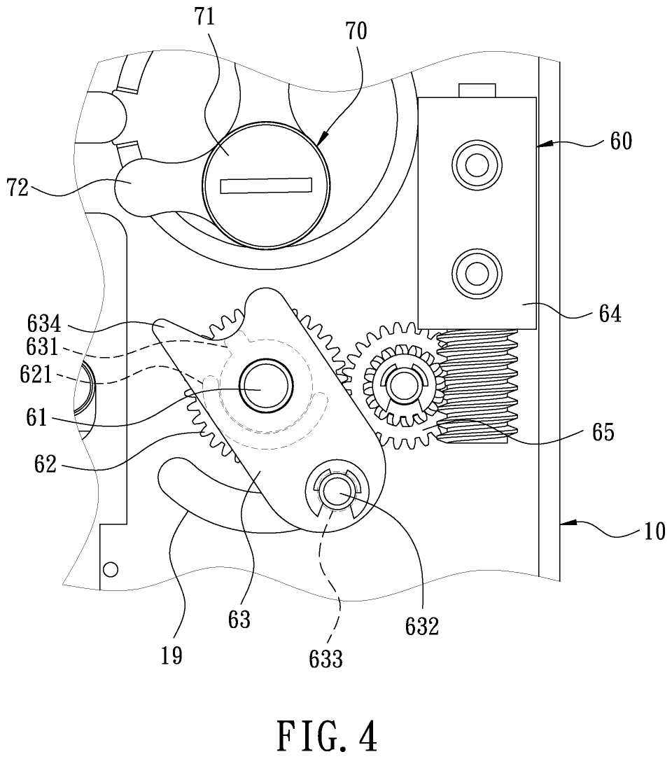

FIG. 4 is a partial cross-sectional view illustrating the electric control unit according to the first embodiment of the present invention. The electric control unit 60 includes a rotating shaft 61 connected to the main body 10. A driving member 62 and a driven member 63 are rotatably sleeved on the rotating shaft 61. The driving member 62 is arranged coaxially with the driven member 63 and can rotate relative to the main body 10. One side of the driving member 62, facing the driven member 63, has a driving portion 621. One side of the driven member 63, facing the driving member 62, has a driven portion 631 corresponding to the driving portion 621. In this embodiment, the driving portion 621 is an arc-shaped block, and the driven portion 631 is a protrusion. The driven portion 631 is located within the rotation range of the driving portion 621. As shown in FIG. 2, a force-receiving portion 23 is disposed behind the square tongue 20, and the driven member 63 includes a force-applying portion 632 corresponding to the force-receiving portion 23. In this embodiment, the force-receiving portion 23 is a long groove, and the force-applying portion 632 is a protruding post and is inserted in the long groove. The electric control unit 60 further has a power source 64. The power source 64 is connected to the driving member 62. In this embodiment, the driving member 62 is a gear, and the power source 64 is an electric motor and is connected to the driving member 62 via a reduction gear 65. The main body 10 further has a restricting arc groove 19. The driven member 63 has a restricting post 633 corresponding to the restricting arc groove 19 for guiding and restricting the rotation range of the driven member 63.

As shown in FIG. 4, in this embodiment, the manual control unit 70 is a key-operated lock and has a lock cylinder 71. The lock cylinder 71 is a conventional structure, so it will not be repeated here. The driven member 63 includes a pushed portion 634. The manual control unit 70 includes a pushing portion 72 corresponding to the pushed portion 634. The pushing portion 72 of the manual control unit 70 links the pushed portion 634 to drive the driven member 63 to rotate.

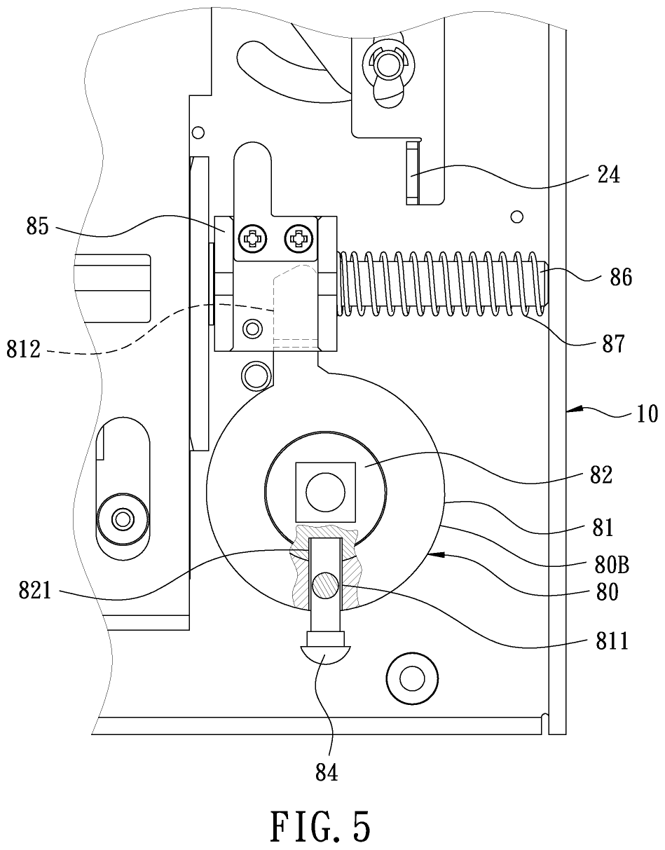

FIG. 5 is a partial cross-sectional view illustrating the handle control unit according to the first embodiment of the present invention. The handle control unit 80 includes a rotating seat 81, a connecting seat 82 at the center of the rotating seat 81, a handle 83 connected to the connecting seat 82, and a positioning pin 84. The rotating seat 81 has a positioning hole 811. The connecting seat 82 has a positioning groove 821 corresponding to the positioning hole 811. The positioning pin 84 is selectively disposed between the positioning hole 811 and the positioning groove 821. When the handle 83 is turned, the connecting seat 82 drives the rotating seat 81 via the positioning pin 84, or the positioning pin 84 is selectively moved out of the positioning hole 811 and the positioning groove 821 so that the connecting seat 82 is idling relative to the rotating seat 81 and is unable to drive the rotating seat 81. In this embodiment, the handle control unit 80A arranged on the outer side of the door is idling, while the handle control unit 80B arranged on the inner side of the door is able to drive the rotating seat 81. The square tongue 20 includes an extension portion 24. A push portion 812 is disposed on the periphery of the rotating seat 81. A slide seat 85 is disposed between the push portion 812 and the extension portion 24. The slide seat 85 can slide along a guide post 86. A handle spring 87 is disposed on the guide post 86. The handle spring 87 is located between the other side of the slide seat 85 opposite to the push portion 812 and the side wall of the main body 10.

FIG. 6 is a schematic view of the first embodiment of the present invention when the door is closed and locked. The door lock case 100 is usually mounted on a door. The door has a door frame and a door panel that can rotate relative to the door frame. The door frame is formed with a square tongue hole and an oblique tongue hole, which is the prior art and will not be repeated here. For ease of illustration, the door is not shown in the figure. When the door panel is in a closed and locked state, the square tongue 20 is in the locked position, the oblique tongue 30 is in the extended position, and the anti-prying tongue 40 is in the closed position. In this state, the square tongue 20 extends into the square tongue hole of the door frame, and the oblique tongue 30 extends into the oblique tongue hole of the door frame, and the oblique tongue 30 is blocked by the restricting member and cannot move, so that the door is closed and locked.

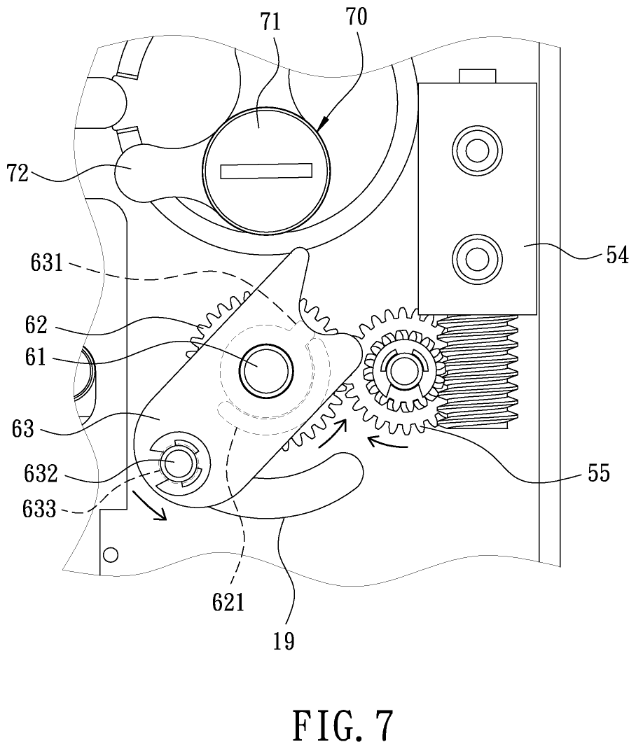

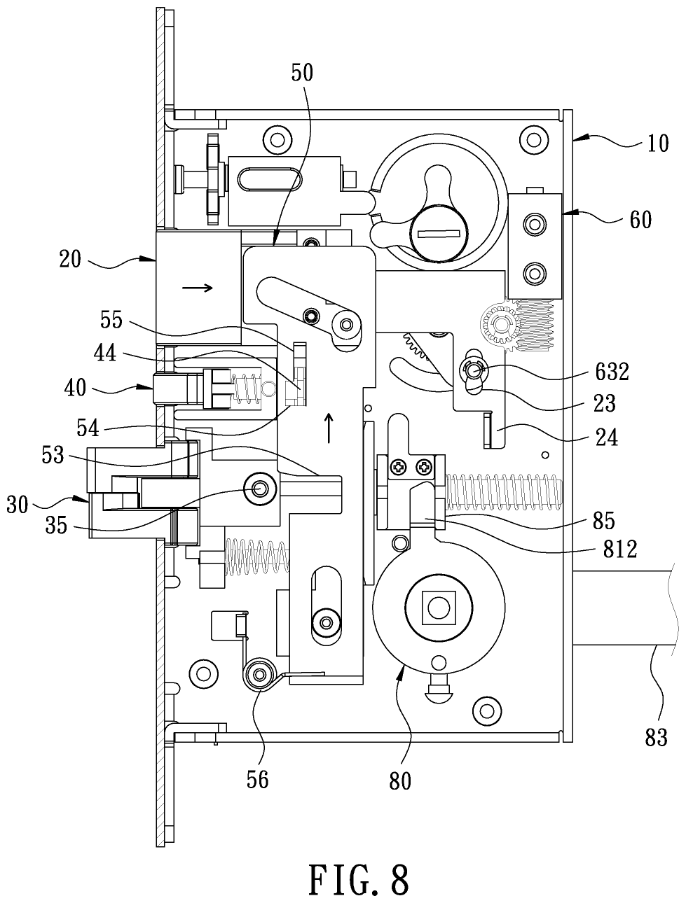

FIG. 7 is a schematic view of the first embodiment of the present invention when the door is unlocked by the electric control unit. FIG. 8 is a schematic view of the first embodiment of the present invention when the door is closed and unlocked. When the user enters the correct unlocking command via an access control system, such as a card reader, a fingerprint reader or a password reader, to activate the power source 64, the driving portion 62 is first driven to rotate by the power source 64, so that the driving portion 621 of the driving member 62 drives the driven portion 631 to rotate the driven member 63. Then, the driven member 63 drives the force-receiving portion 23 via the force-applying portion 632 to drive the square tongue 20 to move to the unlocking position as shown in FIG. 8, and the restricting member 50 is driven to move to the second position. At this time, the square tongue 20 is separated from the square tongue hole of the door frame, achieving the purpose of unlocking. The user can open the door as long as the door panel is directly opened so that the oblique tongue 30 is guided by the door frame to first move to the retracted position and then return to the extended position.

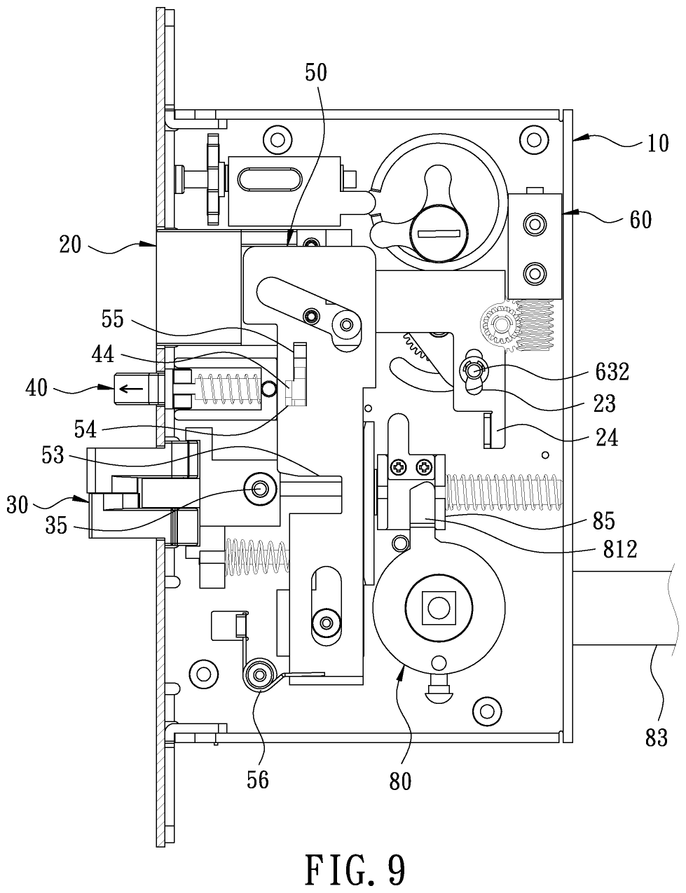

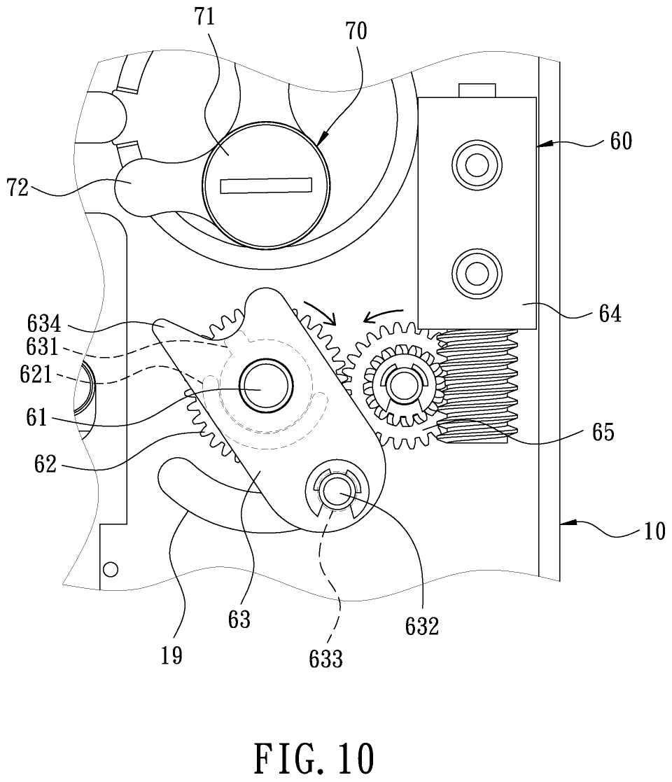

FIG. 9 is a schematic view of the first embodiment of the present invention when the door is opened and unlocked. FIG. 10 is a schematic view of the first embodiment of the present invention, wherein the electric control unit is rotated reversely. After the user pushes the door panel to be open, the anti-prying tongue 40 is moved to the door-opening position, and the anti-prying tongue stopper 44 is blocked by the anti-prying tongue positioning portion 54 so that the restricting member 50 cannot move. In this way, the square tongue 20 is restricted to the unlocked position. As shown in FIG. 10, when the square tongue 20 is moved to the unlocked position, the power source 64 drives the driving member 62 to move reversely to a clutch position. At this time, a distance is kept between the driving portion 621 and the driven portion 631 without contacting each other. The power source 64 can determine the timing to drive the driving member 62 to move reversely via timing, detecting current and voltage changes or setting sensors.

FIG. 11 is a schematic view of the first embodiment of the present invention when the door is to be closed. When the user closes the door panel and the door lock case 100 touches the door frame, but the door panel is not in the correct door-closing position, the oblique tongue 30 is pressed by the door frame to move to the retracted position, and the anti-prying tongue 40 is also pressed by the door frame to move to the closed position. In this state, although the anti-prying tongue stopper 44 is moved into the longitudinal groove 55 by the anti-prying tongue positioning portion 54, the oblique tongue stopper 35 is moved to the oblique tongue positioning portion 53. Thus, the restricting member 50 still cannot move, but the square tongue 20 is restricted to the unlocking position.

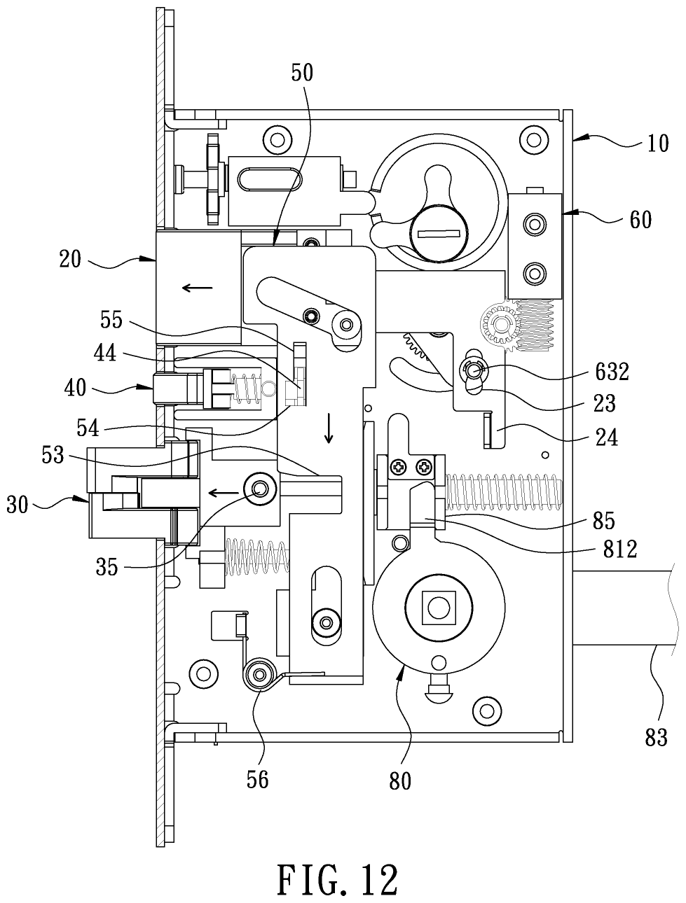

FIG. 12 is a schematic view of the first embodiment of the present invention after the door is closed. When the door panel is further moved to the correct door-closing position, that is, the oblique tongue 30 is aligned with the oblique tongue hole of the door frame, the oblique tongue 30 is moved to the extended position. The anti-prying tongue 40 is continuously pressed by the door frame to be in the closed position. In this state, the oblique tongue stopper 35 is disengaged from the oblique tongue positioning portion 53, and the anti-pry tongue stopper 44 is disengaged from the anti-prying tongue positioning portion 54, so that the restricting member 50 restores the degree of freedom of movement, thereby allowing the square tongue 20 to move. At this time, the restricting member spring 56 elastically drives the restricting member 50 to move towards the first position, and the restricting member 50 drives the square tongue 20 to move to the locked position, thereby achieving the effect of automatic locking when the door is closed.

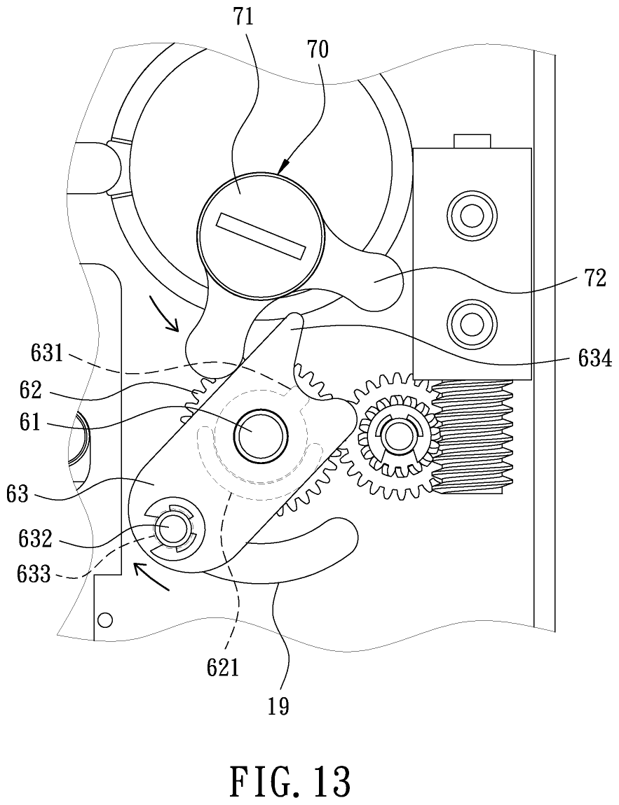

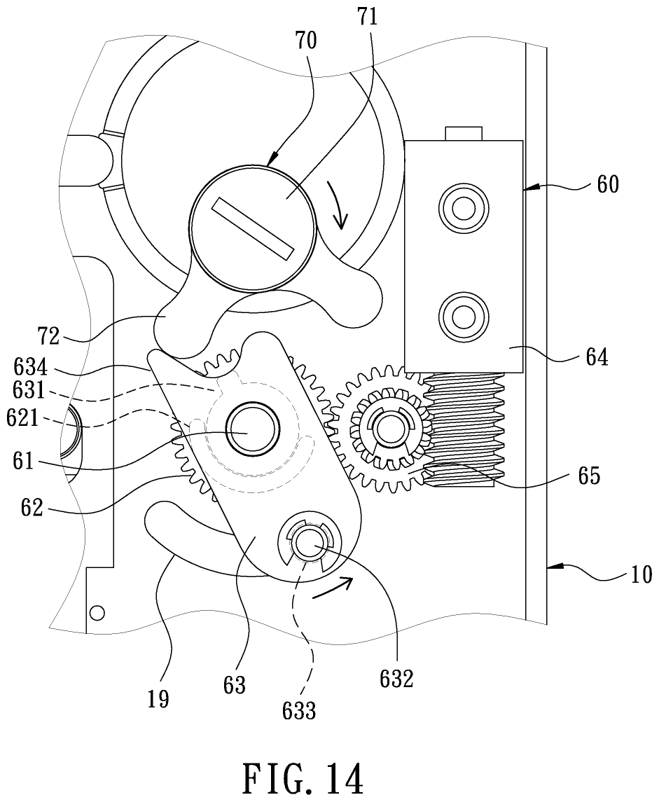

FIG. 13 and FIG. 14 are schematic views of the use of the manual control unit of the first embodiment of the present invention. When the square tongue 20 moves to the unlocking position, the power source 64 drives the driving member 62 to move reversely to the clutch position as shown in FIG. 10. The distance is kept between the driving portion 621 and the driven portion 631, so that the driven member 63 is rotated clockwise or counterclockwise relative to the driving portion 62. In this state, the user can use an external key to turn the lock cylinder 71. The lock cylinder 71 drives the pushed portion 634 via the pushing portion 72 to rotate the driven member 63. Then, the square tongue 20 is driven to the locked position as shown in FIG. 13, or the square tongue 20 is driven to the unlocked position as shown in FIG. 14. Thereby, the square tongue 20 can be driven manually to move between the locked position and the unlocked position.

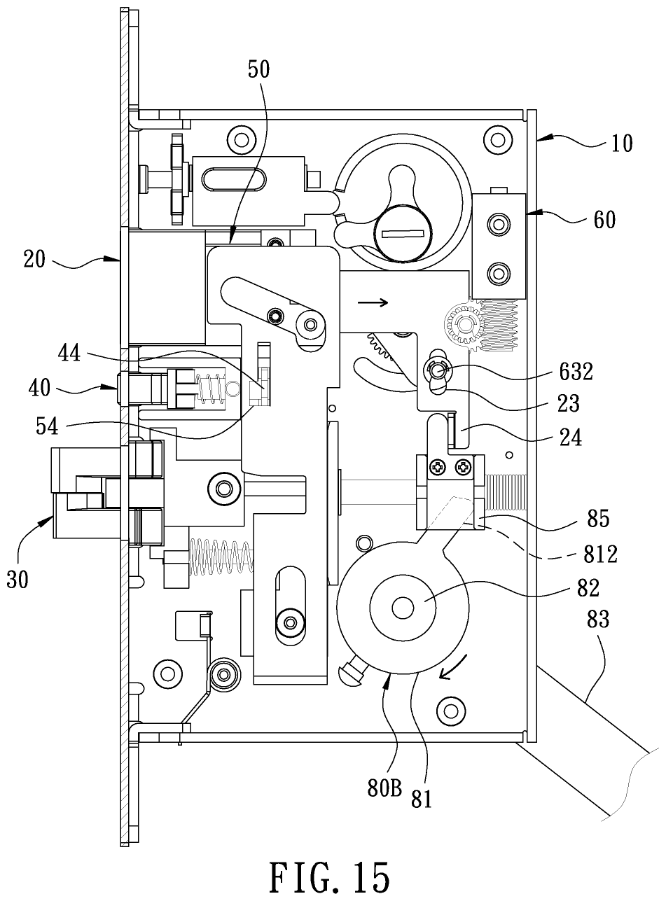

FIG. 15 is a schematic view of the use of the handle control unit of the first embodiment of the present invention. When the driving member 62 is in the clutch position, the user can directly turn the handle 83. The handle 83 drives the push portion 812 to move the slide seat 85, so that the slide seat 85 drives the extension portion 24 to move the square tongue 20 from the locked position to the unlocked position. Thereby, when the door lock case 100 is in the locked state, the user directly uses the handle control unit 80 for unlocking. The door lock case 100 has a more intuitive and convenient operation mode. When an emergency occurs, such as a fire, it is convenient for the user to escape.

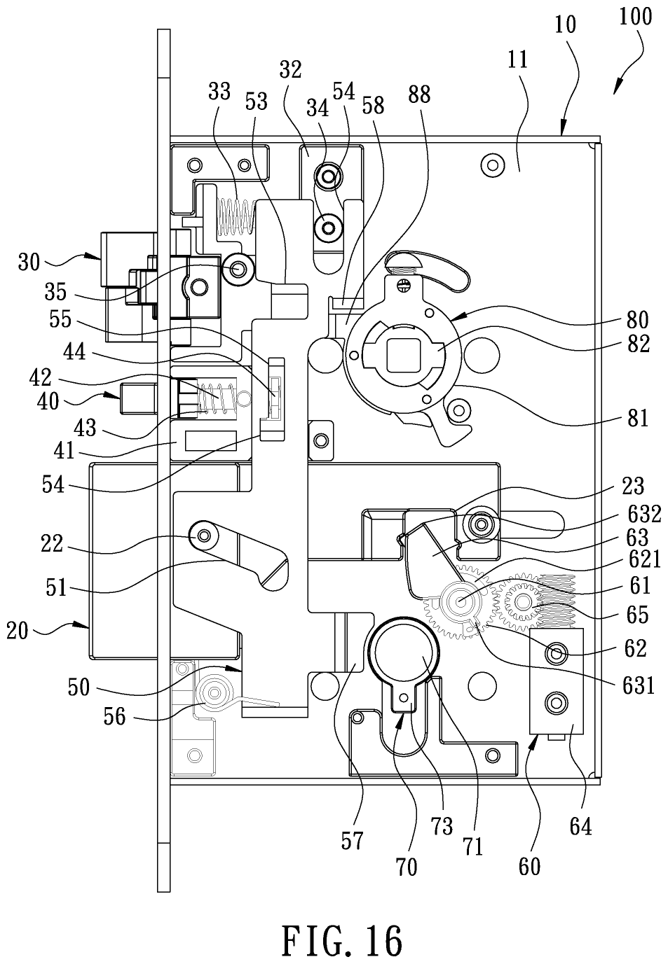

FIG. 16 is a cross-sectional view according to a second embodiment of the present invention. In this embodiment, the door lock case is a European standard door lock case, and also includes the main body 10. The main body 10 also includes the square tongue 20, the oblique tongue 30, the anti-spying tongue 40, the restricting member 50, the electric control unit 60, the manual control unit 70, and the handle control unit 80. The second embodiment is substantially similar to the first embodiment with the exceptions described hereinafter. In this embodiment, the force-receiving portion 23 is a notch, and the force-applying portion 632 is a push block. The restricting member 50 further includes a lock cylinder extension portion 57. The manual control unit 70 includes a lock cylinder abutting portion 73. The lock cylinder abutting portion 73 drives the lock cylinder extension portion 57, so that the square tongue 20 is driven by the restricting member 50 to move. The restricting member 50 further includes a handle extension portion 58. The handle control unit 80 includes a handle abutting portion 88. The handle abutting portion 88 drives the handle extension portion 58, so that the square tongue 20 is driven by the restricting member 50 to move. In addition to a US standard door lock case or a European standard door lock, the door lock case 100 may be a narrow door lock case applied to glass doors. The difference between the narrow door lock case and the US standard door lock case is that the handle control unit 80 is not provided, so its detailed structure will not be repeated. On the other hand, the force-applying portion 632 of the driven member 63 can drive the force-receiving portion 23 of the square tongue 20 in an indirect way, for example, the force-applying portion 632 drives the restricting member 50, then the restricting member 50 drives the force-receiving portion 23.

What is claimed is:

1. A door lock case, comprising:
a main body, having an accommodation space therein, the main body being formed with a square tongue opening and a manual control opening, the square tongue opening and the manual control opening communicating with the accommodation space;
a square tongue, disposed in the accommodation space, the square tongue being configured to slide in an axial direction of the square tongue opening to be in a locked position in which the square tongue is extended out of the square tongue opening or in an unlocked position in which the square tongue is retracted into the square tongue opening, the square tongue having a force-receiving portion;
an electric control unit, disposed in the accommodation space, the electric control unit including a driving member, a driven member and a power source, the driving member having a driving portion, the driven portion having a driven portion corresponding to the driving portion and a force-applying portion corresponding to the force-receiving portion of the square tongue, the power source being connected to the driving member; wherein when the square tongue is in the locked position, the power source is activated to drive the driving member, so that the driving member drives the driven member through the driving portion to drive the driven portion, and then the driven member drives the square tongue to move to the unlocking position through the force-applying member to drive the force-receiving member; when the square tongue is moved to the unlocking position, the power source drives the driving member to move reversely to a clutch position, and a distance is kept between the driving portion and the driven portion;
a manual control unit, disposed at the manual control opening, the manual control unit being configured for a user to move the square tongue manually between the locked position and the unlocked position when the driving member is in the clutch position.

2. The door lock case as claimed in claim 1, wherein the electric control unit includes a rotating shaft connected to the main body, the rotating shaft is rotatably connected to the driving member and the driven member, the driving member is arranged coaxially with the driven member, one side of the driving member, facing the driven member, has the driving portion, one side of the driven member, facing the driving member, has a driven portion corresponding to the driving portion, and the driven portion is located within a rotation range of the driving portion.

3. The door lock case as claimed in claim 1, wherein the driven member includes a pushed portion, the manual control unit is a key-operated lock and has a lock cylinder, the lock cylinder includes a pushing portion corresponding to the pushed portion, when the lock cylinder is driven by an external key to rotate, the pushing portion links the pushed portion to drive the driven member, and then the square tongue is indirectly driven by the driven member.

4. The door lock case as claimed in claim 1, wherein the main body is formed with at least one handle opening communicating with the accommodation space, the door lock case further includes at least one handle control unit, the handle control unit is disposed at the handle opening and configured to drive the square tongue to move when the driving member is in the clutch position.

5. The door lock case as claimed in claim 4, wherein the square tongue includes an extension portion, the handle control unit includes a rotating seat, a connecting seat at a center of the rotating seat and a handle connected to the connecting seat, a push portion is disposed on a periphery of the rotating seat, a slide seat is disposed between the push portion and the extension portion, when the handle is turned, the handle drives the connecting seat to rotate the rotating seat, so that the push portion pushes the slide seat, and the slide seat drives the extension portion to move the square tongue.

6. The door lock case as claimed in claim 1, wherein the main body is formed with an oblique tongue opening and an anti-prying tongue opening, the oblique tongue opening and the anti-prying tongue opening communicate with the accommodation space; the door lock case further comprises an oblique tongue, an anti-prying tongue and a restricting member;
the oblique tongue is disposed in the accommodation space, the oblique tongue being configured to slide in an axial direction of the oblique tongue opening to be in an extended position in which the oblique tongue is extended out of the oblique tongue opening or in a retracted position in which the oblique tongue is retracted into the oblique tongue opening, the oblique tongue includes an oblique tongue stopper;
the anti-prying tongue is disposed in the accommodation space, the anti-prying tongue being configured to slide in an axial direction of the anti-prying tongue opening to be in a door-opening position in which the anti-prying tongue is extended out of the anti-prying tongue opening or in a door-closing position in which the anti-prying tongue is retracted into the anti-prying tongue opening, the anti-prying tongue includes an anti-prying tongue stopper;
the restricting member is disposed in the accommodation space, the restricting member is driven by the square tongue to be in a first position corresponding to the locked position or in a second position corresponding to the unlocked position, the restricting member includes an oblique tongue positioning portion corresponding to the oblique tongue stopper and an anti-pry tongue positioning portion corresponding to the anti-pry tongue stopper;
wherein when the restricting member is in the second position, the oblique tongue is moved to the retracted position and the oblique tongue stopper is blocked by the oblique tongue positioning portion so that the restricting member cannot be moved; the anti-prying tongue is moved to the door-opening position and the anti-prying tongue stopper is blocked by the anti-prying tongue positioning portion so that the restricting member cannot be moved.

7. The door lock case as claimed in claim 6, wherein the restricting member further includes a restricting member spring configured to elastically drive the restricting member to move toward the first position.

8. The door lock case as claimed in claim 6, wherein the restricting member includes a lock cylinder pushed portion, the manual control unit is a key-operated lock and has a lock cylinder, the lock cylinder includes a lock cylinder pushing portion corresponding to the lock cylinder pushed portion, when the lock cylinder is driven by an external key to rotate, the lock cylinder pushing portion links the lock cylinder pushed portion to drive the restricting member, and then the square tongue is indirectly driven by the restricting member.

9. The door lock case as claimed in claim 6, wherein the main body is formed with at least one handle opening communicating with the accommodation space, the door lock case further includes at least one handle control unit, the handle control unit is disposed at the handle opening and configured to drive the square tongue to move when the driving member is in the clutch position.

10. The door lock case as claimed in claim 9, wherein the restricting member includes a handle pushed portion, the handle control unit includes a rotating seat, a connecting seat at a center of the rotating seat and a handle connected to the connecting seat, a handle pushing portion is disposed on a periphery of the rotating seat, when the handle is turned, the handle drives the connecting seat to rotate the rotating seat, so that the handle pushing portion drives the handle pushed portion to move the restricting member, and then the square tongue is indirectly driven by the restricting member.
